(19) United States
(12) Patent Application Publication
(10) Pub. No.: US 2011/0171562 A1
(43) Pub. Date: Jul. 14, 2011

(54) PROCESS FOR FORMING A MEMBRANE-SUBGASKET ASSEMBLY USING VACUUM SEALING

(75) Inventors: Michael K. Budinski, Pittsford, NY (US); Sumeet Bhargava, Rochester, NY (US); Brian K. Brady, North Chili, NY (US); Lewis Dipietro, West Henrietta, NY (US)

(73) Assignee: GM GLOBAL TECHNOLOGY OPERATIONS, INC., Detroit, MI (US)

(21) Appl. No.: 12/684,399

(22) Filed: Jan. 8, 2010

(51) Int. Cl. H01M 2/08; F16J 15/06

(52) U.S. Cl. 429/510; 277/316

(57) ABSTRACT

A UEA-subgasket assembly for a fuel cell system and a method of production thereof is disclosed. The UEA-subgasket assembly includes a membrane electrolyte assembly, diffusion media, and a subgasket, wherein the subgasket permeates into one of the diffusion media to form a substantially fluid-tight seal.

### FIELD OF THE INVENTION

The present disclosure relates to fuel cell systems, and more particularly to a membrane-subgasket assembly used in fuel cell systems and a method of production thereof.

### BACKGROUND OF THE INVENTION

Fuel cells have been proposed as a clean, efficient, and environmentally responsible power source for electric vehicles and various other applications. In particular, fuel cells have been identified as a potential alternative for the traditional internal-combustion engine used in modern automobiles.

A common type of fuel cell is known as a proton exchange membrane (PEM) fuel cell. The PEM fuel cell includes a unitized electrode assembly (UEA) disposed between a pair of fuel cell plates such as bipolar plates, for example. The UEA includes a diffusion medium disposed adjacent an anode face and a cathode face of a membrane electrolyte assembly (MEA). The electrode faces typically include a finely divided catalyst, such as platinum, for example, supported on carbon particles and mixed with an ionomer. The diffusion media facilitate a delivery of gaseous reactants, typically hydrogen and oxygen, to an active region of the MEA for an electrochemical fuel cell reaction. The diffusion media also aid in the management of water byproduct within the fuel cell.

Typically, the MEA includes an electrolyte membrane sandwiched between a cathode electrode and an anode electrode. A subgasket that follows a periphery of the fuel cell plate abuts the MEA. The subgasket may be a stiff film having electrical insulating properties. An inner edge of the subgasket defines the active region of the MEA. The subgasket electrically insulates the anode side of the MEA from the cathode side of the MEA. A sealing portion disposed on the subgasket militates against the gaseous reactants from escaping the fuel cell.

Prior art subgaskets have incorporated designs having a constant thickness from the active region, across and past the sealing portion. The prior art subgaskets, despite being functional, may result in a shortened life of the fuel cell. The prior art subgaskets may be relatively thick (a thick subgasket) when compared to a thickness of the MEA. A high contrast of thickness between the thick subgasket and the MEA may lead to a localized area of high compression. The localized areas of high compression may lead to crushed diffusion media, cracked anode electrodes or cathode electrodes, plate deformation, and shearing of the electrolyte membrane, any of which may lead to a poor performance of the fuel cell. Alternately, the prior art subgaskets may be relatively thin (a thin subgasket) compared to a thickness of the MEA. Accordingly, the thin subgasket may be caused to deflect by a flow of reactant gases through the fuel cell.

Generally, the MEA may degrade at the subgasket as a result of one of a UEA over-compression and a UEA under-compression, Degradation of the MEA as a result of the UEA over-compression may be caused by a swelling of the electrolyte membrane as well as manufacturing processes used to form the UEA. The swelling of the electrolyte membrane may affect a length, a width, and a thickness of the MEA. The thickness of the MEA increasing as a result of the swelling creates a compressive load variance across the UEA. The compressive load variance across the UEA creates a stress concentration at the inner subgasket edge. The stress concentration at the inner subgasket edge negatively affects a life of the MEA. Additionally, the thickness of the MEA increasing as a result of the swelling may increase the compressive load on the UEA in the subgasket area, causing a permanent deformation of the bipolar plate and adjacent diffusion media.

Additionally, the manufacturing processes of the UEA requiring compressive forces may degrade the electrolyte membrane of the MEA. Production of the UEA typically involves hot pressing of the components, thereby bonding the components together. Hot pressing may cause the inner subgasket edge to shear the electrolyte membrane along the contact edge of the subgaskets and the electrolyte membrane. A shear in the electrolyte membrane may result in a crossover leak (loss of an anode to cathode gas barrier) or a short (where adjacent diffusion media or electrodes make a direct or electrical contact).

Degradation of the MEA as a result of the UEA under-compression may occur in a tenting region adjacent the inner subgasket edge. The tenting region is an area of the UEA adjacent the subgasket edge where the compressive load on the MEA is significantly reduced or eliminated. The diffusion media may act to bridge the step formed by an inner edge thickness of the subgasket. The diffusion media may flexibly conform across the step formed by an inner edge thickness of the subgasket, resulting in a wedge shaped span located within the tenting region. Upon humidification of the electrolyte membrane of the MEA, the length and the thickness of the MEA may increase. The humidified electrolyte membrane may swell into the tenting region. As a result of the UEA under-compression, the electrolyte membrane may buckle. A buckling of the electrolyte membrane may cause one of the anode electrode and the cathode electrode formed thereon to crack.

It would be desirable to develop a UEA-subgasket assembly for a fuel cell and a method of production thereof, wherein manufacturing costs are minimized and production output is optimized.

### SUMMARY OF THE INVENTION

In concordance and agreement with the present invention, a UEA-subgasket assembly for a fuel cell and a method of production thereof, wherein manufacturing costs are minimized and production output is optimized, has been surprisingly discovered.

In one embodiment, the UEA-subgasket assembly for a fuel cell, comprises: a unitized electrode assembly including an electrolyte membrane disposed between an anode electrode and a cathode electrode, and a porous diffusion medium disposed adjacent at least one of the anode electrode and the cathode electrode; and a subgasket disposed adjacent the unitized electrode assembly, wherein at least a portion of the subgasket permeates the diffusion medium to form a substantially fluid-tight seal.

In another embodiment, a method for producing the UEA-subgasket assembly comprises the steps of: providing a unitized electrode assembly including an electrolyte membrane disposed between an anode electrode and a cathode electrode, and a porous diffusion medium disposed adjacent at least one of the anode electrode and the cathode electrode; providing a subgasket; providing a positioning and retaining device; disposing the unitized electrode assembly in the positioning and retaining device; disposing the subgasket adjacent the unitized electrode assembly; and causing at least a portion of the subgasket to permeate the diffusion medium to form a substantially fluid-tight seal.

In another embodiment, a method for producing the UEA-subgasket assembly comprises the steps of: providing a unitized electrode assembly including an electrolyte membrane disposed between an anode electrode and a cathode electrode, and a porous diffusion medium disposed adjacent at least one of the anode electrode and the cathode electrode; providing a subgasket disposed adjacent the electrolyte membrane; providing a positioning and retaining device including a cavity; providing a thermal sealing device; disposing the unitized electrode assembly in the cavity of the positioning and retaining device; disposing the subgasket adjacent the unitized electrode assembly; creating a vacuum between the unitized electrode assembly and the subgasket; and heating at least a portion of the subgasket with the thermal sealing device, wherein the vacuum and the heating cause the at least a portion of the subgasket to melt and permeate the diffusion medium to form a substantially fluid-tight seal.

### DRAWINGS

The above, as well as other advantages of the present invention will become readily apparent to those skilled in the art from the following detailed description, particularly when considered in the light of the drawings described hereafter.

FIG. 1 illustrates a schematic, exploded perspective view of a PEM fuel cell stack (only two fuel cells shown) according to an embodiment of the invention;

FIG. 2 is a schematic, fragmentary cross-sectional view of a UEA disposed in a positioning and retaining device, the UEA having a subgasket disposed thereon according to an embodiment of the invention;

FIG. 3 is a schematic, fragmentary cross-sectional view of the UEA illustrated in FIG. 2, wherein a thermal sealing device is disposed adjacent the subgasket;

FIG. 4 is a schematic, fragmentary cross-sectional view of the UEA illustrated in FIGS. 2 and 3, wherein the subgasket has permeated into a portion of the diffusion media of the UEA to form a UEA-subgasket assembly;

FIG. 5 is a schematic, fragmentary cross-sectional view of the UEA-subgasket assembly illustrated in FIG. 4, wherein the UEA-subgasket assembly has been removed from the positioning and retaining device;

FIG. 6 is a schematic, fragmentary cross-sectional view of the UEA-subgasket assembly illustrated in FIGS. 4 and 5, wherein a laser is disposed adjacent an excess portion of the subgasket;

FIG. 7 is a schematic, fragmentary cross-sectional view of the UEA-subgasket assembly illustrated in FIGS. 4, 5, and 6, wherein the excess portion is trimmed and removed;

FIG. 8 is a schematic, fragmentary cross-sectional view of the UEA-subgasket assembly, wherein the subgasket is a multi-layer sheet or film;

FIG. 9 is a schematic, fragmentary cross-sectional view of a UEA disposed in a positioning and retaining device, the UEA having a subgasket disposed thereon according to another embodiment of the invention;

FIG. 10 is a schematic, fragmentary cross-sectional view of a UEA-subgasket assembly removed from the positioning and retaining device, wherein the UEA-subgasket assembly includes the UEA illustrated in FIG. 9;

FIG. 11 is a schematic, fragmentary cross-sectional view of a UEA disposed in a positioning and retaining device, the UEA having a subgasket disposed thereon according to another embodiment of the invention, wherein a thermal sealing device includes a carrier element disposed thereon; and

FIG. 12 is a schematic, fragmentary cross-sectional view of a UEA-subgasket assembly, wherein the UEA-subgasket assembly includes the UEA illustrated in FIG. 11.

### DETAILED DESCRIPTION OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

For simplicity, only a two-cell stack (i.e. one bipolar plate) is illustrated and described hereafter, it being understood that a typical stack will have many more such cells and bipolar plates.

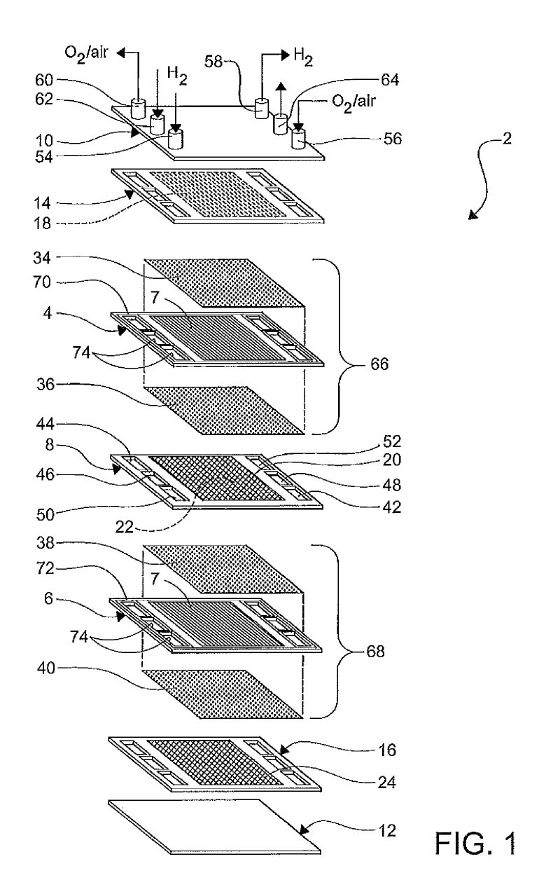

FIG. 1 depicts an illustrative fuel cell stack 2 having a pair of MEAs 4, 6 separated from each other by an electrically conductive bipolar plate 8. Each of the MEAs 4, 6 includes an electrolyte membrane 7 sandwiched between an anode electrode (not shown) and a cathode electrode (not shown). The MEAs 4, 6 and bipolar plate 8 are stacked together between a pair of clamping plates 10, 12 and a pair of unipolar end plates 14, 16. The clamping plates 10, 12 are electrically insulated from the end plates 14, 16 by a gasket or a dielectric coating (not shown). The end plate 14, both working faces of the bipolar plate 8, and the end plate 16 include respective active areas 18, 20, 22, 24. The active areas 18, 20, 22, 24 are typically flow fields for distributing gaseous reactants such as hydrogen gas and air over the anode electrode and the cathode electrode, respectively, of the MEAs 4, 6.

The bipolar plate 8 is typically formed by a conventional process for shaping sheet metal such as stamping, machining, molding, or photo etching through a photolithographic mask, for example. In one embodiment, the bipolar plate 8 is formed from unipolar plates which are then joined. It should be further understood that the bipolar plate 8 may also be formed from a composite material. In one particular embodiment, the bipolar plate 8 is formed from a graphite or graphite-filled polymer.

Gas-permeable diffusion media 34, 36, 38, 40 are adjacent the anodes and the cathodes of the MEAs 4, 6. The end plates 14, 16 are disposed adjacent the diffusion media 34, 40, respectively, while the bipolar plate 8 is disposed adjacent the diffusion medium 36 on the anode face of the MEA 4. The bipolar plate 8 is further disposed adjacent the diffusion medium 38 on the cathode face of the MEA 6.

The bipolar plate 8, end plates 14, 16, and the MEAs 4, 6 each include a cathode supply aperture 42 and a cathode exhaust aperture 44, a coolant supply aperture 46 and a coolant exhaust aperture 48, and an anode supply aperture 50 and an anode exhaust aperture 52. Supply manifolds and exhaust manifolds of the fuel cell stack 2 are formed by an alignment of the respective apertures 42, 44, 46, 48, 50, 52 in the bipolar plate 8, end plates 14, 16, and the MEAs 4, 6. The hydrogen gas is supplied to an anode supply manifold via an anode inlet conduit 54. The air is supplied to a cathode supply manifold of the fuel cell stack 2 via a cathode inlet conduit 56. An anode outlet conduit 58 and a cathode outlet conduit 60 are also provided for an anode exhaust manifold and a cathode exhaust manifold, respectively. A coolant inlet conduit 62 is provided for supplying liquid coolant to a coolant supply manifold. A coolant outlet conduit 64 is provided for removing coolant from a coolant exhaust manifold. It should be understood that the configurations of the various inlets 54, 56, 62 and outlets 58, 60, 64 in FIG. 1 are for the purpose of illustration, and other configurations may be chosen as desired.

A pair of united electrode assemblies (UEAs) 66, 68 of the fuel cell stack 2 may be assembled in a configuration substantially shown in FIG. 1. The UEA 66 includes the MEA 4 sandwiched between the diffusion media 34, 36. The UEA 68 includes the MEA 6 sandwiched between the diffusion media 38, 40. The components of the UEAs 66, 68 are assembled during production thereof and affixed to one another by any conventional process such as hot pressing, for example. An adhesive may be used between individual components where necessary.

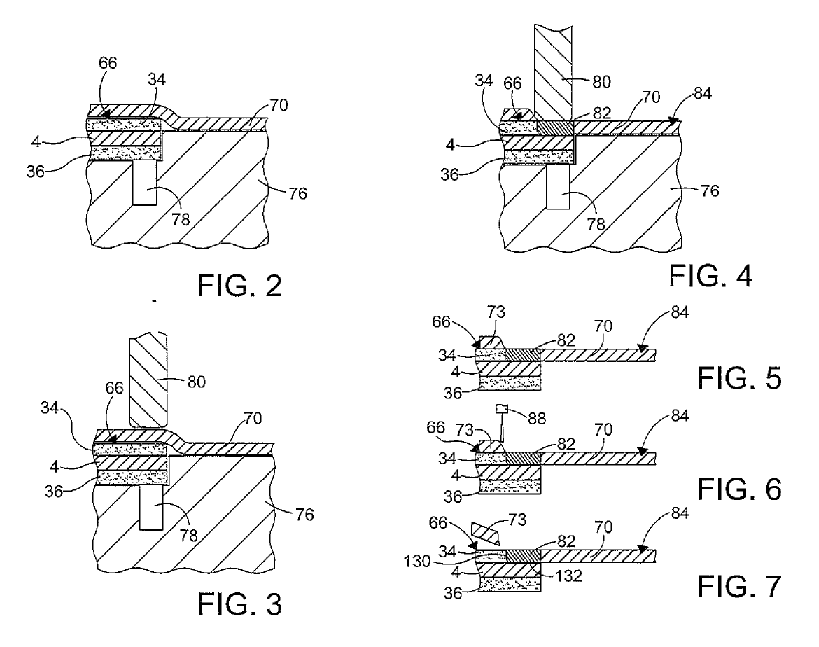

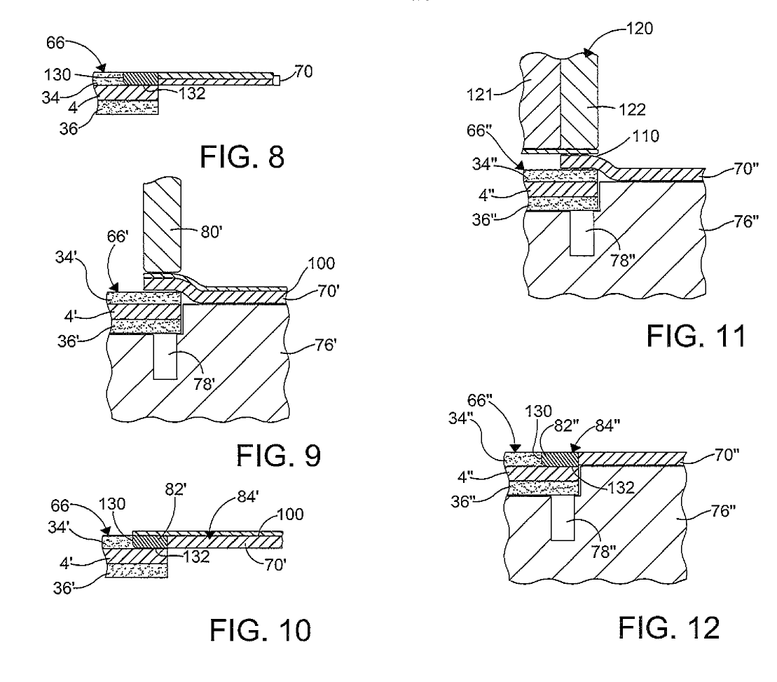

A first subgasket 70 is disposed on the UEA 66. A second subgasket 72 is disposed on the UEA 68. The subgaskets 70, 72 provide a seal and electrical insulation between the UEAs 66, 68 and one of the bipolar plate 8 and the end plates 14, 16. The subgaskets 70, 72 may substantially follow a periphery of the UEAs 66, 68. A plurality of apertures 74 formed in the subgaskets 70, 72 correspond to the apertures 42, 44, 46, 48, 50, 52 formed in the bipolar plate 8, the MEAs 4, 6, and the end plates 14, 16. In the embodiment shown, the subgaskets 70, 72 are formed from a polymeric material such as a polypropylene, for example. It is understood, however, that other materials having electrical insulating properties and low melting points such an olefin variant material, for example, may be used to form the subgaskets 70, 72 if desired. It is further understood that the subgaskets 70, 72 can be a single layer sheet or film as shown in FIGS. 2-7 and a multi-layer sheet or film as shown in FIG. 8, for example. The multi-layer subgaskets 70, 72 optimize resistance to subgasket-intrusion into a feed region of the end plates 14, 16 and the bipolar plate 8. It is recognized that a bending stiffness of the multi-layer subgaskets 70, 72 is proportional to a section modulus of the subgaskets 70, 72 and a thickness thereof cubed.

For simplicity, only the assembly of the UEA 66 with the subgasket 70 is illustrated and described hereinafter, it being understood that the assembly of the UEA 68 with the subgasket 72 is substantially similar thereto.

FIGS. 2-7 show a method of assembling the UEA 66 with the subgasket 70 according an embodiment of the invention. The UEA 66 is disposed in a cavity formed in a positioning and retaining device 76. Thereafter, the subgasket 70 is disposed on a surface of the diffusion medium 34 of the UEA 66 as shown in FIG. 2. It is understood that the subgasket 70 can be disposed on an opposing surface of the diffusion medium 36 if desired. A vacuum is created between the subgasket 70 and the UEA 66, and the positioning and retaining device 76. The vacuum facilitates a proper alignment of the subgasket 70 onto the UEA 66. The vacuum is caused by air drawn from between the subgasket 70, the UEA 66, and the positioning and retaining device 76, and into at least one aperture 78. Heat is applied to the subgasket 70 along at least one of the periphery of the UEA 66 and a periphery of the apertures 42, 44, 46, 48, 50, 52 formed in the MEA 4, causing the subgasket 70 to melt. As shown in FIG. 3, a thermal sealing device 80 is employed to apply the heat to the subgasket 70. It is recognized, however, that the heat can be applied using other methods and devices as desired. The vacuum causes the melted portion of the subgasket 70 to permeate into an open pore structure of the diffusion medium 34 as shown in FIG. 4, thereby creating a substantially fluid-tight seal 82 and a UEA-subgasket assembly 84. Subsequently, the UEA-subgasket assembly 84 is rapidly cooled. The vacuum is deactivated and, as illustrated in FIG. 5, and the UEA-subgasket assembly 84 is removed from the positioning and retaining device 76. Excess portions of the subgasket 70 are then trimmed and removed from the surface of the diffusion medium 34 leaving the remaining portions of the subgasket 70 fixedly attached to the UEA 66. In the embodiment shown, an excess portion 73 of the subgasket 70 is trimmed by a laser 88 and removed from the surface of the diffusion medium 34 by a vacuum suction (not shown). It is understood that the excess portions of the subgasket 70 can be trimmed and removed using other methods and devices as desired.

Referring now to FIGS. 9 and 10, a method of assembling the UEA 66′ with the subgasket 70′ according another embodiment of the invention is shown. References numerals for similar structure in respect of the discussion of FIGS. 1-8 above are repeated with a prime (′) symbol.

The UEA 66′ is disposed in a cavity formed in a positioning and retaining device 76′. Thereafter, the subgasket 70′ is disposed on a surface of the diffusion medium 34′ of the UEA 66′. It is understood that the subgasket 70′ can be disposed on an opposing surface of the diffusion medium 36′ if desired. In the embodiment shown, the subgasket 70′ is a preformed sheet (e.g. the subgasket 70′ is a sheet provided in a substantially final size and shape) and removably attached to a carrier element 100. The carrier element 100 can be any shape and size suitable to receive the subgasket 70′ thereon. As shown, the carrier element 100 is produced from a polyimide material such as Kapton® or a fluorinated polymer such as Teflon® developed by DuPont, for example. It is understood that the carrier element 100 can be produced from other suitable materials as desired. The carrier element 100 facilitates a vacuum sealing of the subgasket 70′. A vacuum is created between the carrier element 100 and the subgasket 70′, the UEA 66′, and a positioning and retaining device 76′. The vacuum facilitates a proper alignment of the subgasket 70′ onto the UEA 66′. The vacuum is caused by air drawn from between the carrier element 100, the subgasket 70′, the UEA 66′, and the positioning and retaining device 76′, and into at least one aperture 78′. Heat is applied to at least a portion of the carrier element 100. The heated portion of the carrier element 100 contacts the subgasket 70′ along at least one of the periphery of the UEA 66′ and the apertures formed in the MEA 4′, causing the subgasket 70′ to melt. As shown in FIG. 9, a thermal sealing device 80′ is employed to apply the heat to the carrier element 100. It is understood that the thermal sealing device 80′ may include heating and non-heating portions as desired. It is further recognized that the heat can be applied using other methods and devices as desired. The vacuum causes the melted portion of the subgasket 70′ to permeate into an open pore structure of the diffusion medium 34′ as shown in FIG. 10, thereby creating a substantially fluid-tight seal 82′ and a UEA-subgasket assembly 84′. Subsequently, the UEA-subgasket assembly 84′ is rapidly cooled. The vacuum is deactivated and the carrier element 100 is removed from the UEA-subgasket assembly 84′. It is understood that the carrier element 100 can be detached from the UEA-subgasket assembly 87′ and reused. Thereafter, the UEA-subgasket assembly 84′ is removed from the positioning and retaining device 76′.

FIG. 11 discloses a method of assembling the UEA 66″ with the subgasket 70″ according another embodiment of the invention. References numerals for similar structure in respect of the discussion of FIGS. 1-10 above are repeated with a prime (″) symbol.

The UEA 66″ is disposed in a cavity formed in a positioning and retaining device 76″. Thereafter, the subgasket 70″ is disposed on a surface of the diffusion medium 34″ of the UEA 66″. It is understood that the subgasket 70″ can be disposed on an opposing surface of the diffusion medium 36″ if desired. In the embodiment shown, the subgasket 70″ is a preformed sheet (e.g. the subgasket 70″ is a sheet provided in a substantially final size and shape). The subgasket 70″ is disposed on the diffusion medium 34″ using a carrier element 110 of a thermal sealing device 120. The carrier element 110 can be any shape and size suitable to receive the subgasket 70″ thereon. As shown, the carrier element 110 is produced from a polyimide material such as Kapton® or a fluorinated polymer such as Teflon® developed by DuPont, for example. It is understood that the carrier element 110 can be produced from other suitable materials as desired. It is further understood that the carrier element 110 can be a surface treatment such as a coating disposed on the thermal sealing device 120, if desired. The carrier element 110 facilitates a vacuum sealing of the subgasket 70″. A vacuum is created between the carrier element 110 and the subgasket 70″, the UEA 66″, and a positioning and retaining device 76″. The vacuum facilitates a proper alignment of the subgasket 70″ onto the UEA 66″. The vacuum is caused by air drawn from between the carrier element 110, the subgasket 70″, the UEA 66″, and the positioning and retaining device 76″, and into at least one aperture 78′. Heat is applied to at least a portion of the carrier element 110 by the thermal sealing device 120. The heated portion of the carrier element 110 contacts the subgasket 70″ along at least one of the periphery of the UEA 66″ and the apertures formed in the MEA 4″, causing the subgasket 70″ to melt. As illustrated in FIG. 11, the thermal sealing device 120 may include at least one heating portion 122 and at least one non-heating portion 124 as desired. It is further recognized that the heat can be applied using other methods and devices as desired. A force of the vacuum causes the melted portion of the subgasket 70″ to permeate into an open pore structure of the diffusion medium 34″ as shown in FIG. 12, thereby creating a substantially fluid-tight seal 82″ and a UEA-subgasket assembly 84″. Subsequently, the UEA-subgasket assembly 84″ is rapidly cooled. The vacuum is deactivated and the thermal sealing device 120, including the carrier element 110, is removed from the UEA-subgasket assembly 84″. Thereafter, the UEA-subgasket assembly 84″ is removed from the positioning and retaining device 76″.

Optionally, subgasket edges 130, 132 of the UEA-subgasket assemblies 84, 84′, 84″ may be further sealed using a sealing material such as a thermoplastic polymer, for example. It is understood that the sealing material can be disposed along the edges 130, 132 using any suitable method and device as desired such as employing an injection device to dispense the sealing material along the edges 130, 132, for example.

While certain representative embodiments and details have been shown for purposes of illustrating the invention, it will be apparent to those skilled in the art that various changes may be made without departing from the scope of the disclosure, which is further described in the following appended claims.

What is claimed is:

1. A UEA-subgasket assembly for a fuel cell, comprising:
a unitized electrode assembly including an electrolyte membrane disposed between an anode electrode and a cathode electrode, and a porous diffusion medium disposed adjacent at least one of the anode electrode and the cathode electrode; and
a subgasket disposed adjacent the unitized electrode assembly, wherein at least a portion of the subgasket permeates the diffusion medium to form a substantially fluid-tight seal.

2. The UEA-subgasket assembly according to claim 1, wherein the subgasket is a multi-layer sheet.

3. The UEA-subgasket assembly according to claim 1, wherein the subgasket is produced from a polymeric material.

4. The UEA-subgasket assembly according to claim 1, wherein the subgasket is a preformed sheet.

5. The UEA-subgasket assembly according to claim 1, wherein the subgasket is removably attached to a carrier element.

6. The UEA-subgasket assembly according to claim 1, wherein at least one edge of the subgasket is sealed using a sealing material.

7. A method for producing a UEA-subgasket assembly, the method comprising the steps of:
providing a unitized electrode assembly including an electrolyte membrane disposed between an anode electrode and a cathode electrode, and a porous diffusion medium disposed adjacent at least one of the anode electrode and the cathode electrode;
providing a subgasket;
providing a positioning and retaining device;
disposing the unitized electrode assembly in the positioning and retaining device;
disposing the subgasket adjacent the unitized electrode assembly; and
causing at least a portion of the subgasket to permeate the diffusion medium to form a substantially fluid-tight seal.

8. The method according to claim 7, wherein the subgasket is a multi-layer sheet.

9. The method according to claim 7, wherein the subgasket is a preformed sheet.

10. The method according to claim 7, wherein at least one edge of the subgasket is sealed using a sealing material.

11. The method according to claim 7, further comprising the steps of:
providing a thermal sealing device;
creating a vacuum between the unitized electrode assembly and the subgasket; and
heating at least a portion of the subgasket with the thermal sealing device, wherein the vacuum and the heating cause the at least a portion of the subgasket to melt and permeate the diffusion medium to form a substantially fluid-tight seal.

12. The method according to claim 11, wherein at least one of the subgasket and the thermal sealing device includes a carrier element.

13. The method according to claim 11, wherein the thermal sealing device includes at least one heating portion and at least one non-heating portion.

14. A method for producing a UEA-subgasket assembly, the method comprising the steps of:
providing a unitized electrode assembly including an electrolyte membrane disposed between an anode electrode and a cathode electrode, and a porous diffusion medium disposed adjacent at least one of the anode electrode and the cathode electrode;
providing a subgasket disposed adjacent the electrolyte membrane;
providing a positioning and retaining device including a cavity;
providing a thermal sealing device;
disposing the unitized electrode assembly in the cavity of the positioning and retaining device;
disposing the subgasket adjacent the unitized electrode assembly;
creating a vacuum between the unitized electrode assembly and the subgasket; and
heating at least a portion of the subgasket with the thermal sealing device, wherein the vacuum and the heating cause the at least a portion of the subgasket to melt and permeate the diffusion medium to form a substantially fluid-tight seal.

15. The method according to claim 14, wherein the subgasket is a multi-layer sheet.

16. The method according to claim 14, wherein the subgasket is a preformed sheet.

17. The method according to claim 14, wherein at least one edge of the subgasket is sealed using a sealing material.

18. The method according to claim 14, wherein at least one of the subgasket and the thermal sealing device includes a carrier element.

19. The method according to claim 14, wherein the thermal sealing device includes at least one heating portion and at least one non-heating portion.

20. The method according to claim 14, further comprising the step of:
providing a laser; and
trimming excess portions of the subgasket with the laser, wherein the excess portions are removed with a vacuum suction.
